(19) United States
(12) Patent Application Publication
(10) Pub. No.: US 2011/0202157 A1
(43) Pub. Date: Aug. 18, 2011

(54) METHOD AND DEVICE FOR MANUFACTURING INDIVIDUAL COSMETIC ARTICLES READY FOR DISPATCH

(76) Inventor: Helmut Spikker, Ahlen (DE)

(21) Appl. No.: 13/029,865

(22) Filed: Feb. 17, 2011

(30) Foreign Application Priority Data
Feb. 18, 2010 (EP) 10 001 657.5

(51) Int. Cl. G05B 19/418; G06F 17/50

(52) U.S. Cl. 700/96

(57) ABSTRACT

A method and device for the manufacture of individual cosmetic articles ready for dispatch includes the steps of: collecting several user inputs regarding an individual composition of a cosmetic substance, a container to receive the substance, an exterior configuration of the container, a packing for the container and exterior configuration of the packing, and individually manufacturing and packing the cosmetic articles in accordance with the user inputs, wherein for each of the several cosmetic articles the following steps are carried out individually in accordance with the user selections: preparing the container to receive the cosmetic substance, manufacturing the exterior configuration of the container, preparing an amount of the cosmetic substance which is to be decanted, filling the container with the amount of the cosmetic substance, closing of the container with a closure, packing the container, and manufacturing the exterior configuration of the packing and dispensing the packing.

### CROSS-REFERENCE TO RELATED APPLICATION

This application claims priority to European Patent Application No. 10 001 657.5, filed on Feb. 18, 2010, the entire disclosure of which is hereby incorporated by reference.

### FIELD OF THE DISCLOSURE

The disclosure relates to a method and device for the manufacturing individual cosmetic articles ready for dispatch, in particular individual perfume articles.

### BACKGROUND OF THE DISCLOSURE

Cosmetic articles are usually products which are manufactured in mass production. Known manufacturing methods and manufacturing plant are geared towards such mass production and aim for a process optimization of the manufacture of a plurality of identical products.

Increasingly, however, a demand also exists for individualized products in the field of cosmetics. In this context, a demand exists for technologies for the individualized manufacture of cosmetic articles.

### SUMMARY OF THE DISCLOSURE

The disclosure provides a method for manufacturing individual cosmetic articles ready for dispatch and a device for carrying out the method, by which individualized cosmetic articles can be manufactured in an efficient and time-saving manner.

The disclosure provides the opportunity of an industrial manufacture of individualized cosmetic articles which are produced singly according to an individual user's selection. Preferably, the proposed technologies are used for the individual manufacture of perfume articles. The customer is enabled to select features of the cosmetic article according to his individual wishes. The individualized specification of the product is integrated into an automated manufacturing process, so that individually configured cosmetic articles can be mass-produced. The advantages of person-specific cosmetic articles on the one hand, and industrial manufacture on the other hand, are thus maintained.

The collecting of the individual user inputs for the development of the cosmetic article can take place via a local terminal at the manufacturing and packing machine or via a terminal connected to a user interface of the machine. For example, provision can be made that the user interface is provided on the basis of a client which is connected to a server, coupled to the manufacturing and packing machine, for the collection of the user inputs. In an embodiment, the collecting of the user inputs takes place via a so-called web-based client, for example using the internet. In this or other developments, the user inputs are collected via a suitable user interface which guides the user with provided menus through the selection of the user inputs which are to be collected. A data set which is compiled here with the information concerning the user selection which has been made is then transferred to the central control device of the manufacturing and packing machine.

The proposed technologies may have particular application in connection with the individualized manufacture of a perfume. Here, provision can be made that the customer or user firstly receives information from a customer adviser concerning the individual composition of a perfume on the basis of available fragrances, in particular in an advisory interview in situ. When an individual composition of the perfume has been decided by the customer after the advisory interview, this selection can be collected via the user terminal. In addition to the composition, the further user selections are then made via the user terminal. The electronic information which is thus generated is then transferred to the manufacturing and packing machine which manufactures the cosmetic article according to the user's specification.

In a further embodiment of the disclosure, the preparation of the container to receive the cosmetic substance in the container supply unit comprises a step for preparation by means of several container dispensers formed in a parallel arrangement, which are filled respectively with different container forms. In connection with the manufacture of individualized perfume articles, different bottles are provided. For the cosmetic articles which are to be manufactured, according to the user selection the corresponding bottle is then introduced into the manufacturing process individually for each article.

In an expedient embodiment of the disclosure, the preparation of the amount of the cosmetic substance which is to be decanted comprises a step for the mixing of one or more base substances with one or more additional substances according to the user selection relating to the individual composition. In the embodiment of the manufacture of individual perfume articles, one or more base fragrances are mixed with one or more additional fragrances. This takes place according to the individual user selection. In particular, provision is made in this context that the user selection establishes relative proportions of one or more base fragrances and relative proportions of one or more additional fragrances, so that an individualized perfume results. Furthermore, the user selection also concerns the total amount of the perfume. In accordance with these input requirements, the preparation of the amount of perfume takes place in the mixing and filling unit by the selected bottle being filled.

In an embodiment of the disclosure, the method further comprises the collecting of a user text selection in the user selection concerning the exterior configuration of the container and the production of a container inscription with the user text selection on the container on manufacture of the exterior configuration of the container. In this process step, the user is given the possibility of providing the cosmetic article, in particular the perfume bottle, with a text which he has specified himself. For example, for the exterior configuration of the container a label is produced with the user's text selection and is then stuck onto the perfume bottle which has been selected by the user. The label production comprises in particular the printing of the label by means of a printing system which has for example one or more ink jet printers.

The collecting of the user text selection may further comprise the following steps: checking the user text selection for prohibited text and suppressing the user text selection if, on checking the user text selection, it is discovered that the user text selection contains text which is classified as prohibited in accordance with previously stored checking information. In this way, it is ruled out that prohibited inscriptions are produced, for example with a content which is racist or is a violation of personal rights. In an embodiment, the user text section is compared for this purpose with texts, stored by software, which constitute prohibited contents. In this way, a filtering of the user text selection takes place. Provision can also be made that on collection of the user text selection, the user is presented with text suggestions at the user terminal, which are available for the user to select. In an embodiment of the method, a spell check and correction takes place for the user text selection. On generating the electronic information concerning the collected user inputs, the user text selection is preferably provided in accordance with the so-called Uni-code. In this way, a language-independent character encoding is achieved, which is then processed in the manufacturing and packing machine.

In an embodiment of the disclosure, the collected user text selection is converted into image data which are transferred as part of the electronic information from the user terminal to the central control device of the manufacturing and packing machine. This makes possible the provision of the electronic information for transfer to the manufacturing and packing machine independently of characters.

In a further embodiment of the disclosure, it is provided that the closing of the container with the closure further comprises the following steps: provision of a pump device, which is configured to convey the cosmetic substance out of the container by means of manual operation, manufacturing a conveying tube on the pump device in accordance with the size of the container, and arranging the pump device on the container. In connection with the manufacture of an individualized perfume article, after the selection of a pump device suitable for the container which has been selected by the user, a conveying tube is manufactured which is adapted with regard to its length to the pump and to the selected container. The conveying tube is prepared individually for every single cosmetic article. The pump device is arranged together with the conveying tube on the neck of the container, after which an associated cap is then applied onto the pump device. An atomizer is also situated in the cap, in order to discharge the perfume according to the user selection in the case of the individual perfume article.

In a further embodiment of the disclosure, the method further comprises the following steps: collecting a further user text selection in the user selection concerning the exterior configuration of the packing and production of a packing inscription with the further user text selection on the packing on manufacture of the exterior configuration of the packing, wherein the packing inscription is produced by means of inscription units for several packings simultaneously. The handling of the user text selection in connection with the external configuration of the packing can be carried out in accordance with the handling of the text described above in connection with the inscription on the container.

In an expedient embodiment of the disclosure, it is provided that in the production of the packing inscription, the user text selection is applied by means of laser processing directly onto the packing. The production of the packing inscription therefore takes place in an embodiment by means of direct lasing on the surface of the packing. The packing configuration unit preferably comprises several laser inscription units, so that several packings can be inscribed simultaneously and/or the front and back can be inscribed simultaneously.

In an embodiment of the disclosure, the packing of the container further comprises the provision of an inner packing fitting the container, and comprises the arranging of the filled container in the inner packing. The arranging of the container can take place before or after the insertion of the fitting inner packing, which is also designated as an inliner, into the packing.

In an embodiment of the disclosure, the method further comprises the following steps: producing an article identification for the individual cosmetic article in the central control device, allocating the article identification to the electronic information concerning the respective user input and application of the article identification onto the packing during the manufacture of the exterior configuration of the packing. The article identification, which is produced individually for each of the manufactured cosmetic articles and is formed for example with alphanumeric characters, makes possible for example an identification of the article on later re-ordering by the customer. The user selections concerning the individual composition of the cosmetic substance, the container for receiving the cosmetic substance, the exterior configuration of the container, the packing for the container and the exterior configuration of the packing are stored electronically, allocated to the article identification. If the individual cosmetic article is to be manufactured and packed at a later time, the central control device can access the electronic information which has been stored in this way, and can carry out the manufacturing process again individually.

For developments of the device for the manufacture of individual cosmetic articles ready for dispatch, the explanations named in connection with identical method executions apply accordingly.

### BRIEF DESCRIPTION OF THE DRAWINGS

The disclosure is explained in detail below on the basis of embodiments with reference to figures, in which are shown:

FIG. 1 shows a schematic block illustration of an arrangement for a method for the manufacture of individual cosmetic articles ready for dispatch,

FIG. 2 shows a schematic block illustration of a plant component of a manufacturing and packing machine for the manufacture of individual cosmetic articles ready for dispatch,

FIG. 3 shows a schematic block illustration of a further plant component of the manufacturing- and packing machine, which adjoins the plant component in FIG. 2,

FIG. 4 shows a front part of a container supply unit from the front,

FIG. 5 shows a rear part of the container supply unit from the front,

FIG. 6 shows a container configuration unit from the front,

FIG. 7 shows a mixing and filling unit from the front

FIG. 8 shows a closure unit from the front,

FIG. 9 shows a packing unit from the front and

FIG. 10 shows a packing configuration unit and a downstream lifting conveyor from the front.

### DETAILED DESCRIPTION OF EMBODIMENTS OF THE DISCLOSURE

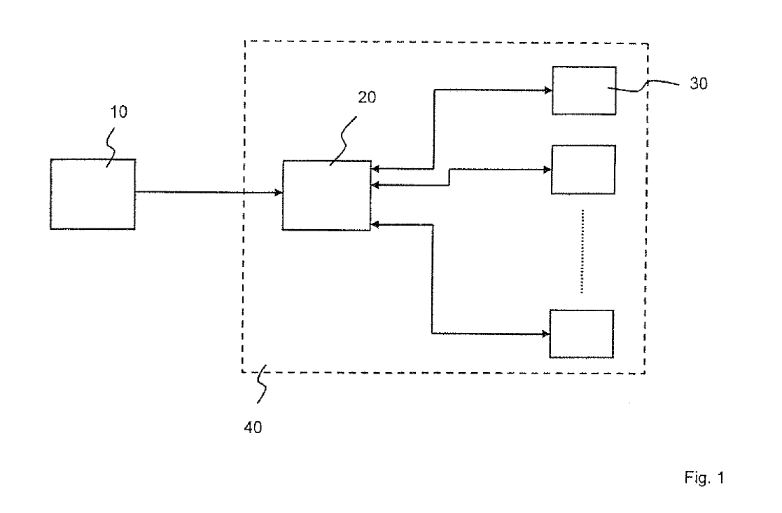

FIG. 1 shows a schematic block illustration of a system for the manufacture of individual cosmetic articles ready for dispatch, in particular of individual perfume articles. In the method, firstly a user selection for the cosmetic article which is to be manufactured is collected by means of a user terminal 10. The user terminal 10 is for example a personal computer on which the user is presented with a user interface with menu control by means of an application software, in order to collect the individual user selection(s). In an embodiment, the following user inputs are collected via the user terminal 10: an individual material composition of a perfume, a container selection for a container to receive the perfume, an exterior configuration of the container, a packing for the container and an exterior configuration of the packing. Optionally, further user inputs concerning the product can be collected.

In addition, provision can be made so that a user selection is collected for a pump device of the perfume article. In connection with the user selection concerning the individual material composition of the perfume, user inputs concerning one or more base fragrances and one or more additional fragrances are collected. In this way, an individual perfume is composed. The user can have made this selection previously in an advisory interview, in which he is informed by a trained person with regard to the fragrance options and their mixing together. The trained person can also carry out sample mixtures here in situ, so that the customer can test various fragrance variants. The selection which is finally made with regard to the individual fragrance composition is then collected via the user terminal 10.

For the selection of the container (bottle) for the individual perfume, various options are indicated to the user on a display area of the user terminal 10, from which the user can choose. The same applies to the individual selection of a packing to receive the perfume bottle. Furthermore, user inputs concerning the exterior configuration of the perfume bottle and the packing are collected via the user terminal 10. Here, provision can be made that image and/or lettering elements are provided to the user for selection, from which the user can choose. In addition or alternatively, provision is made that the user can make individual text inputs for the inscription of the perfume bottle and/or the packing.

In connection with the user text selection, individual text inputs of the user are checked after input, such that in particular prohibited texts are blocked. The user is then informed that the prohibited texts are not available for the inscription of the perfume bottle or the packing. The user is requested to indicate a different inscription. In an embodiment, provision is also made that the text input of the user is checked for spelling. Optionally, further text and/or image filters can come into use.

In addition, data is collected regarding the user, in particular concerning a billing address and a dispatch address, which may also be identical. Proceeding from the collected user inputs, an electronic data set is then generated, which comprises information concerning the user inputs. The electronic data set is communicated according to FIG. 1 to a central control device 20 of a manufacturing and packing machine 40. The implementation of the user terminal 10 with regard to data processing technology can take place within a so-called client-server arrangement. For example, the user interface for collecting the user inputs is provided within a so-called web client. Further data processing technology installations, for example further server devices, can be arranged between the user terminal 10 and the central control device 20. Proceeding from the received user inputs, the central control device 20 controls plant units 30 of the manufacturing and packing machine 40, so that the cosmetic article which was selected and defined by the user, which in the described example embodiment is an individual perfume, is manufactured accordingly.

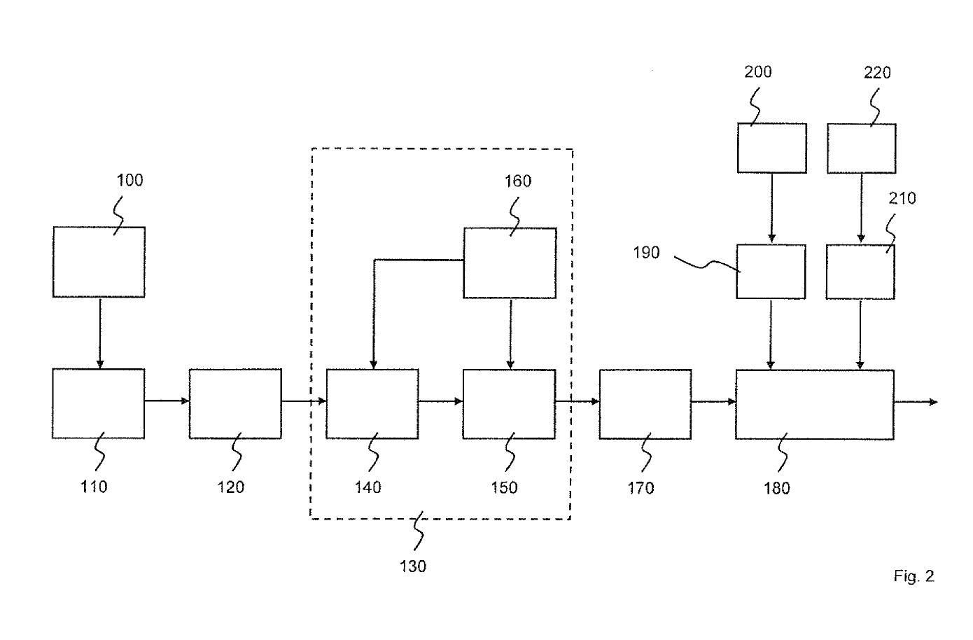

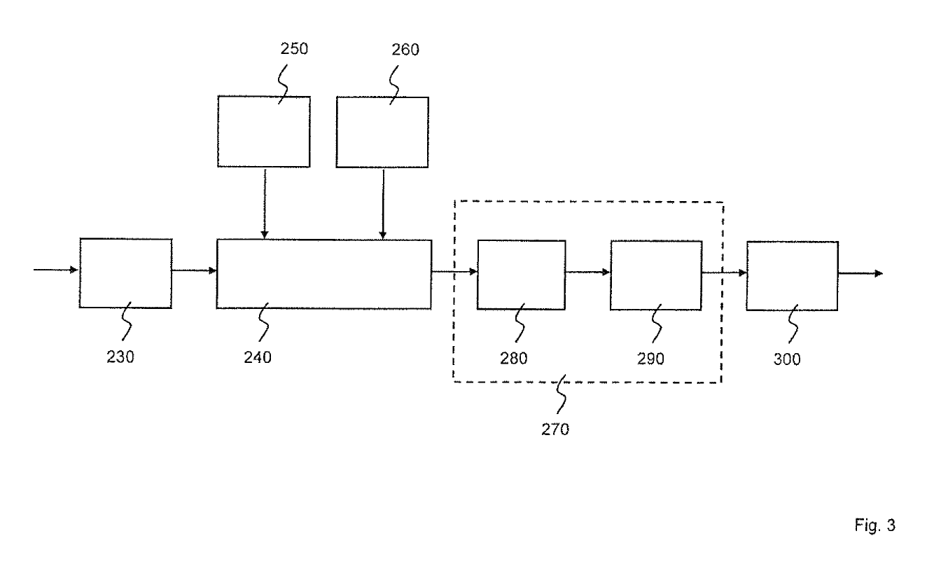

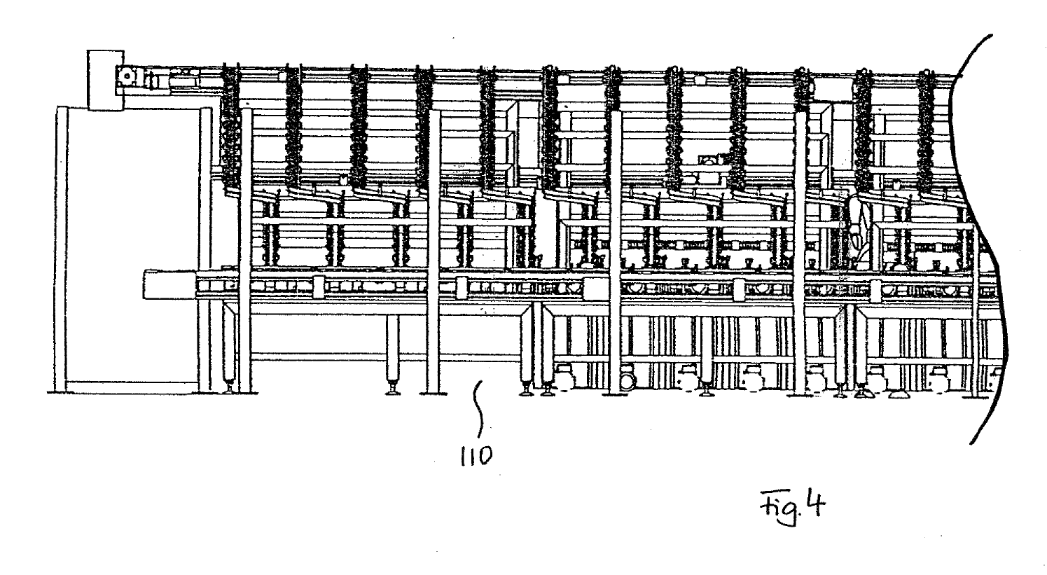

The manufacturing process is explained in further detail below with reference to schematic block illustrations in FIGS. 2 and 3 for the manufacturing and packing machine 40. FIGS. 4 to 10 show plant components of the manufacturing and packing machine 40 in an embodiment.

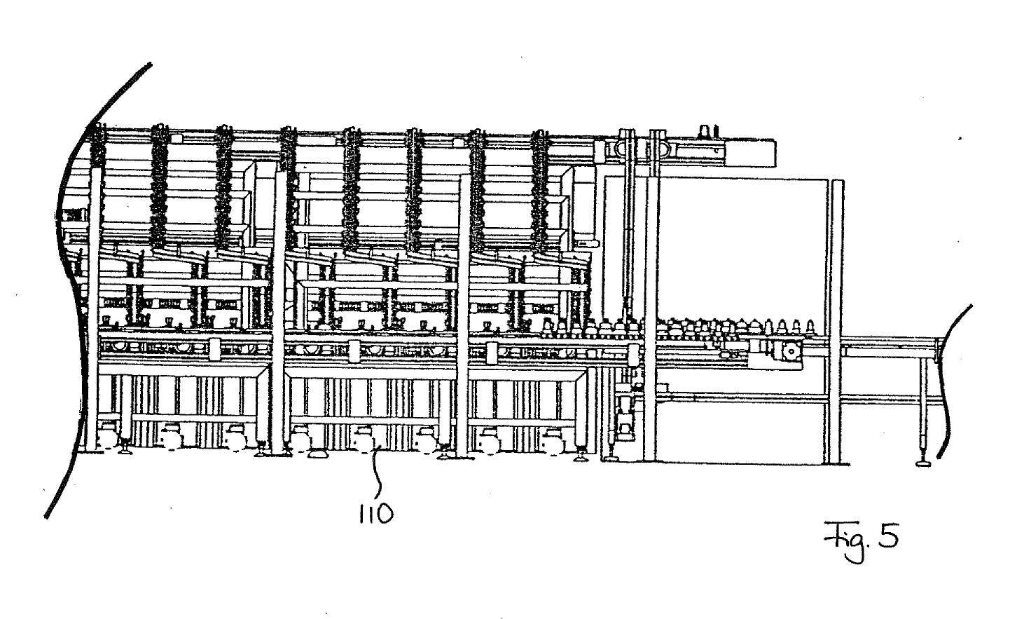

The steps of the method described below for the manufacture of an individual cosmetic article, ready for dispatch, in the form of a perfume, are carried out according to the previously collected user inputs. A perfume bottle is provided, in accordance with the user selection, from a container store 100 via a container supply unit 110. FIGS. 4 and 5 show an illustration with a front and a rear part of the container supply unit 110 in an embodiment. The perfume bottle then arrives in a manufacturing transportation container or module to a module 120 for linking product to order by RFID. Here, an RFID module arranged on the manufacturing transportation container is provided with electronic information concerning the individual manufacture of the article. This electronic information on the RFID chip is read in the further manufacturing process at the individual machine stations and is utilized for the individualized manufacture.

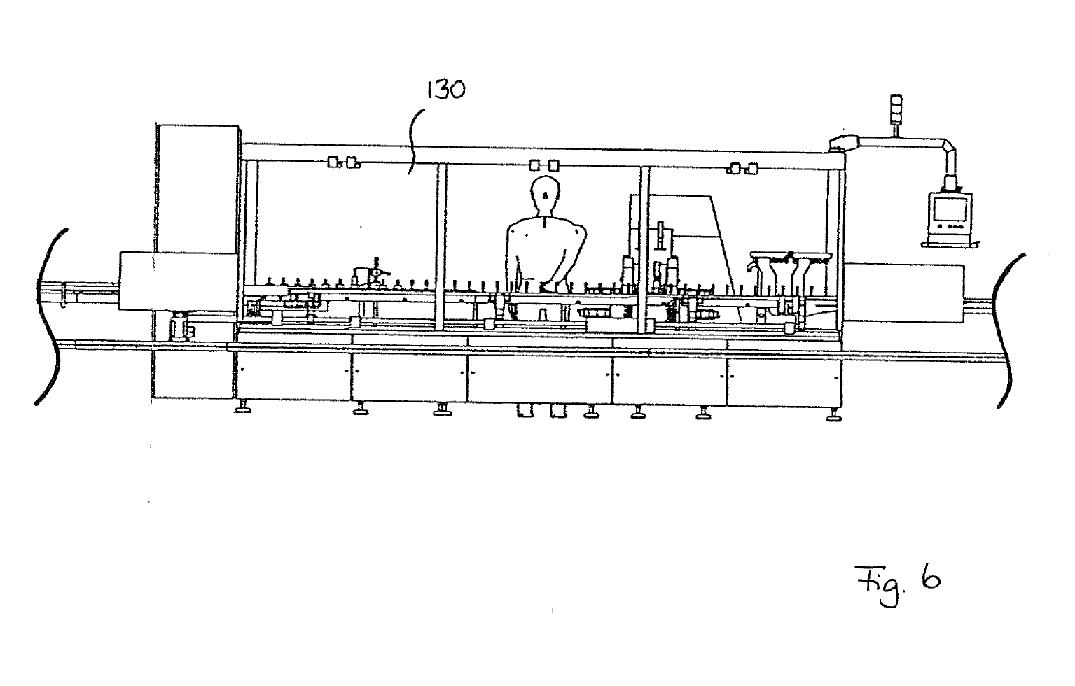

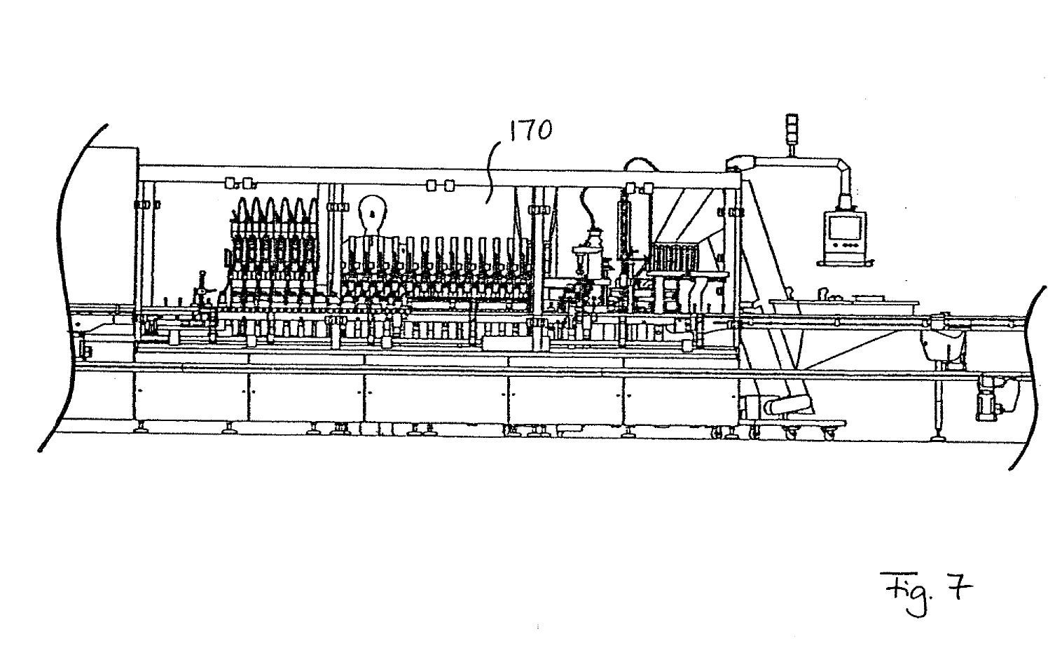

A container configuration unit 130 is formed with a bottom label module 140, a label module 150 and a label-producing module 160. FIG. 6 shows an illustration with the container configuration unit 130 in an embodiment. In the label-producing module 160, adhesive labels are produced according to the user selection, by blank labels being printed by means of a printing system, which comprises for example one or several ink jet printers. The labels which are thus produced are then stuck by means of the bottom label module 140 and the label module 150 on the bottom and on the side or sides of the perfume bottle. The perfume bottle is then filled with the perfume in a mixing and filling unit 170, with the said perfume corresponding in its composition to the user selection with regard to the one or more base fragrances and the one or more additional fragrances. FIG. 7 shows an illustration with the mixing and filling unit 170 in an embodiment.

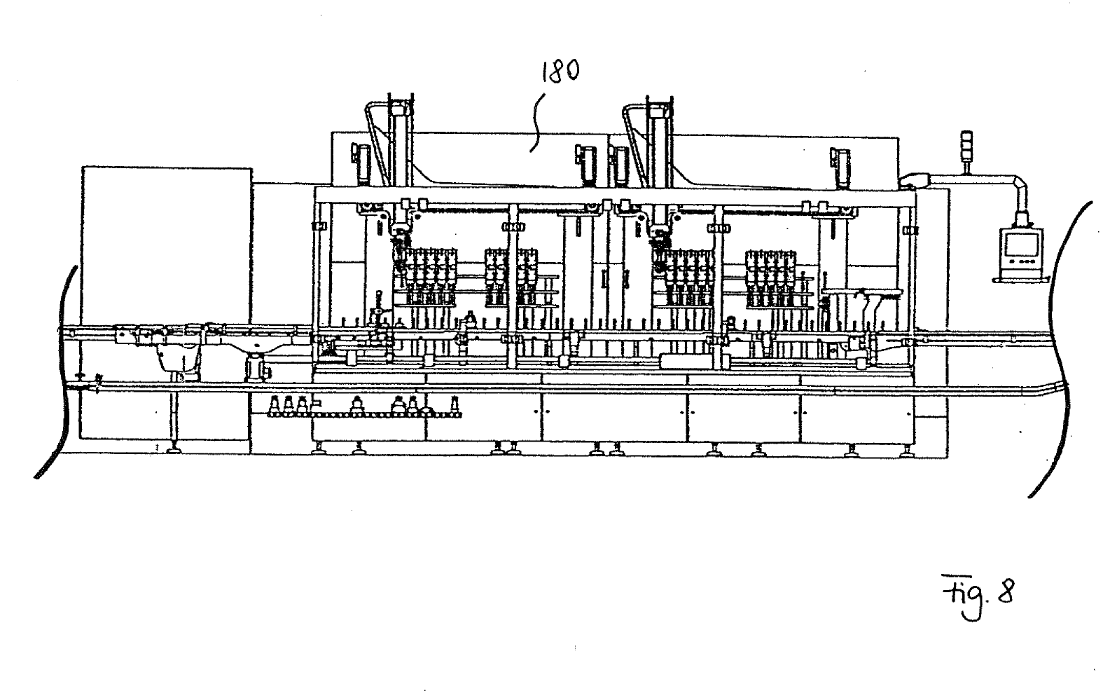

From the mixing and filling unit 170, the perfume bottle, which has now been provided with one or more labels and filled with the perfume, arrives at a closure unit 180, in which the perfume bottle is provided with a spray pump and an associated cap, after a spray tube, arranged on the spray pump, has been previously matched with regard to its length to the selected perfume bottle, which can take place in particular by means of a tube shortening. FIG. 8 shows an illustration with the closure unit 180 in an embodiment. The spray pump corresponding to the user selection, and the associated cap, arrive at the closure unit 180 via supply modules 200, 220 and sorting modules 190, 210, which are associated with different pump devices.

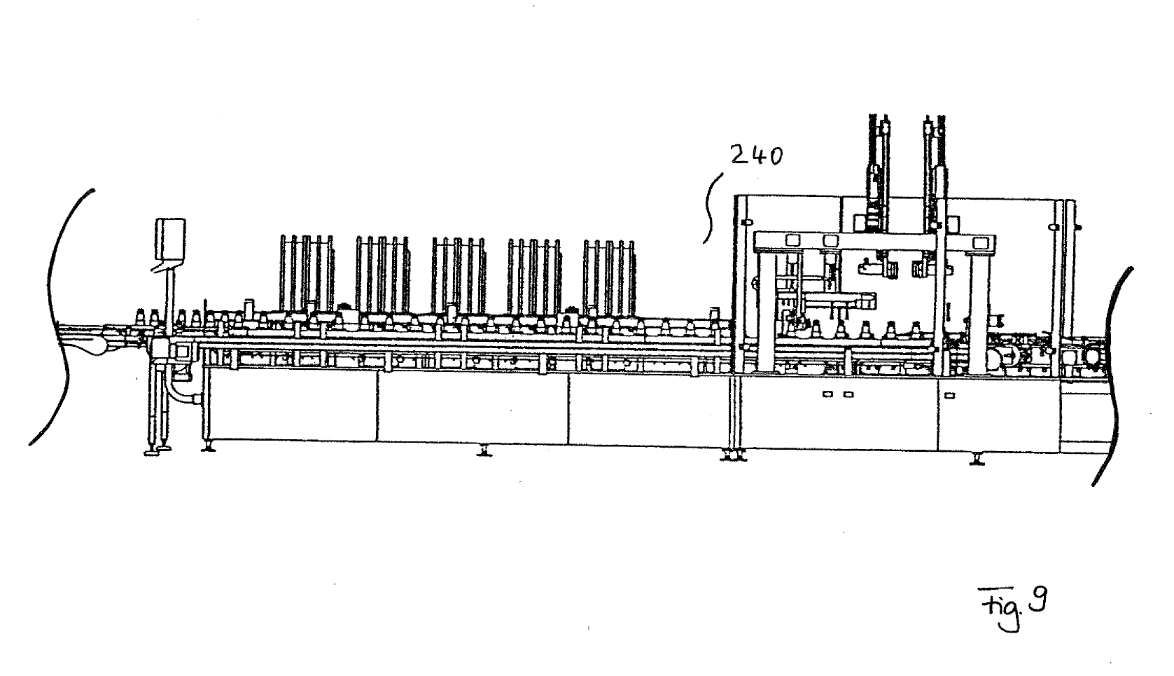

The manufacturing process then continues in the plant section illustrated in FIG. 3. In a cap-fitting module 230 the perfume bottle is provided with a selected cap corresponding to the user selection. In a packing unit 240, in which a packing is prepared corresponding to the user selection by means of a folded box preparation unit 240, the placing of the perfume bottle into the packing takes place. For this purpose, the packing unit 250 is further in connection with a supply device 260 for so-called inliners which serve as packing inserts corresponding to the selected perfume bottle. FIG. 9 shows an illustration with the packing unit 240 in an embodiment. The filled and closed perfume bottle is inserted into a packing insert matched to the exterior bottle shape, in order to then arrange the packing insert and the bottle arranged hereto in the packing.

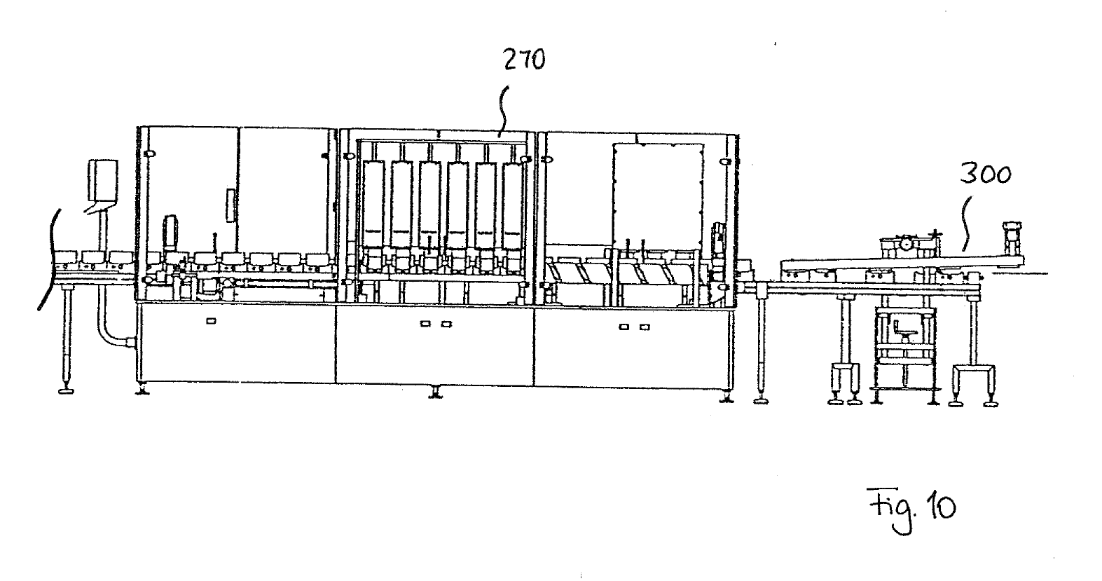

Thereafter, the packing is configured from the exterior according to the user selection in a downstream packing configuration unit 270. For this, the packing configuration unit 270 has laser modules 280, 290 for inscribing the packing on the front and rear side. Preferably, the exterior configuration of the packing, selected by the user, in particular with regard to an inscription text, is lased directly onto the exterior surface of the packing. Here, within a parallelizing of process steps, provision is made to inscribe and configure several packings simultaneously by means of several laser units. The perfume article which is thus manufactured is then guided over a lifting conveyor 300 and dispensed through this. FIG. 10 shows an illustration with the packing configuration unit 270 and the lifting conveyor 300 in an embodiment.

In accordance with the example embodiment previously described, each perfume article which is manufactured by the manufacturing and packing machine 40 is produced individually according to the associated user selection. For each article, the units or modules of the manufacturing and packing machine 40 are actuated individually, in order to thus manufacture in an individualized manner the article defined by the user. The advantages of an individual product definition by the customer are combined with the industrialized manufacturing process. The manufacturing device has a high degree of flexibility, in order to implement the corresponding user selection for each individual article during manufacture. At the same time, however, the manufacture takes place in a fully automated manner.

The features of the disclosure which are disclosed in the above description, in the claims and the figures can be of significance both individually and also in any desired combination for the realization of the disclosure in its various embodiments.

What is claimed is:

1. A method for manufacturing of individual cosmetic articles ready for dispatch, comprising the steps of:
collecting several user inputs, to which respectively different user selections for an individual cosmetic article are associated, by means of a user terminal, wherein for each of the several user inputs the following are collected:
a user selection concerning an individual composition of a cosmetic substance,
a user selection concerning a container to receive the cosmetic substance,
a user selection concerning an exterior configuration of the container,
a user selection concerning a packing for the container and
a user selection concerning an exterior configuration of the packing,
transferring electronic information concerning the several collected user inputs from the user terminal to a central control device of a manufacturing and packing machine via an electronic data connection,
generating machine control data based on the received electronic information using the central control device,
successive individual manufacture and packing of the cosmetic articles in accordance with the several user inputs, by the manufacturing and packing machine being controlled according to the machine control data, wherein the following steps are carried out by machine units of the manufacturing and packing machine for each of the several cosmetic articles individually:
preparing the container to receive the cosmetic substance in accordance with the user selection concerning the container in a container supply unit,
manufacturing the exterior configuration of the container in accordance with the user selection concerning the exterior configuration of the container in a container configuration unit,
preparing an amount of the cosmetic substance which is to be decanted in accordance with the user selection concerning the individual composition and filling the container with the amount of the cosmetic substance in a mixing and filling unit,
closing the container with a closure in a closure unit,
packing the container in accordance with the user selection concerning the packing of the container in a packing unit,
manufacturing the exterior configuration of the packing according to the user selection concerning the exterior configuration of the packing in a packing configuration unit, and
dispensing of the packing via an output unit.

2. The method of claim 1, wherein the preparation of the container to receive the cosmetic substance in the container supply unit comprises a step for preparation by means of several container dispensers formed in a parallel arrangement, which are respectively filled with different container forms.

3. The method of claim 1, wherein the preparation of the amount of the cosmetic substance which is to be decanted comprises a step for mixing one or more base substances with one or more additional substances in accordance with the user selection concerning the individual composition.

4. The method of claim 1, further comprising the steps of:
collecting a user text selection in the user selection concerning the exterior configuration of the container and
producing a container inscription with the user text selection on the container on manufacturing of the exterior configuration of the container.

5. The method of claim 4, wherein the step of collecting the user text selection further comprises the steps of:
checking the user text selection for prohibited text and
suppressing the user text selection if, on checking the user text selection, it is discovered that the user text selection contains text which is classified as prohibited in accordance with previously stored checking information.

6. The method of claim 4, wherein the collected user text selection is converted into image data which are transferred as part of the electronic information from the user terminal to the central control device of the manufacturing and packing machine.

7. The method of claim 1, wherein the step of closing the container with the closure further comprises the following steps:
providing a pump device configured to convey the cosmetic substance out of the container by means of manual operation,
manufacturing a conveying tube on the pump device in accordance with the size of the container and
arranging the pump device on the container.

8. The method of claim 1, further comprising the steps of:
collecting a further user text selection in the user selection concerning the exterior configuration of the packing and
producing a packing inscription with the further user text selection on the packing on manufacture of the exterior configuration of the packing, wherein the packing inscription is produced by means of labelling units for several packings simultaneously.

9. The method of claim 8, wherein on production of the packing inscription, the user text selection is applied by laser processing directly onto the packing.

10. The method of claim 1, wherein the step of packing the container further comprises the steps of:
providing an inner packing fitting the container and
arranging the filled container in the inner packing.

11. The method of claim 1, further comprises the steps of:
producing an article identification for the individual cosmetic article in the central control device,
allocating the article identification to the electronic information concerning the respective user input and
applying the article identification onto the packing during the manufacture of the exterior configuration of the packing.

12. A device for manufacturing of individual cosmetic articles ready for dispatch, comprising:
a user terminal for collecting several user inputs, to which respectively different user selections for an individual cosmetic article are allocated, wherein the user terminal is configured to collect for each of the several user inputs:
a user selection concerning an individual composition of a cosmetic substance,
a user selection concerning a container to receive the cosmetic substance,
a user selection concerning an exterior configuration of the container,
a user selection concerning the packing for the container and
a user selection concerning the exterior configuration of the packing, and
a manufacturing and packing machine with a central control and
an electronic data connection between the user terminal and the central control device,
wherein the electronic data connection is configured to transfer electronic information concerning the several collected user inputs from the user terminal to the central control device,
wherein the central control device is configured to generate machine control data based on the received electronic information, and wherein the manufacturing and packing machine is configured to manufacture and to pack cosmetic articles in accordance with the several user inputs in succession individually, by the manufacturing and packing machine being controlled in accordance with the machine control data and the following steps are carried out for each of the several cosmetic articles individually:
preparing the container to receive the cosmetic substance in accordance with the user selection concerning the container in a container supply unit,
manufacturing the exterior configuration of the container in accordance with the user selection concerning the exterior configuration of the container in a container configuration unit,
preparing an amount of the cosmetic substance to be decanted in accordance with the user selection concerning the individual composition and filling the container with the amount of the cosmetic substance in a mixing and filling unit,
closing the container with a closure in a closure unit,
packing the container in accordance with the user selection concerning the packing of the container in a packing unit,
manufacturing the exterior configuration of the packing in accordance with the user selection concerning the exterior configuration of the packing in a packing configuration unit and
dispensing the packing via an output unit.
